(19) United States
(12) Patent Application Publication
(10) Pub. No.: US 2010/0141689 A1
(43) Pub. Date: Jun. 10, 2010

(54) ELECTRONIC SKIN READER

(75) Inventor: Roger Laverne JOHNSON, Arroyo Seco, NM (US)

Correspondence Address: PEARNE & GORDON LLP, 1801 EAST 9TH STREET, SUITE 1200, CLEVELAND, OH, 44114-3108, US

(73) Assignee: KENT DISPLAYS, INC., Kent, OH (US)

(21) Appl. No.: 12/631,133

(22) Filed: Dec. 4, 2009

Related U.S. Application Data
(60) Provisional application No. 61/200,806, filed on Dec. 4, 2008.
(60) Provisional application No. 61/157,661, filed on Mar. 5, 2009.

(51) Int. Cl. G09G 5/10

(52) U.S. Cl. 345/690; 345/88; 345/107

(57) ABSTRACT

A portable electronic device includes a portable electronic device housing having a surface and a primary, light-emissive display. A display skin covers a portion of the surface of the portable electronic device housing. The display skin provides a secondary, light-reflective display. The display skin includes an optically active layer comprising electrooptical material. A first electrode layer is disposed on a first side of the optically active layer proximal the surface of the portable electronic device housing. A second electrode layer disposed on a second side of the optically active layer distal of the surface of the portable electronic device housing. Electronic circuitry selectively activates the optically active layer such that images including portions of a document are selectively displayed by the display skin. The display skin is capable of maintaining a display of a selectively displayed portion of the document while the primary display is in an unpowered state.

### CROSS-REFERENCE TO RELATED APPLICATIONS

Benefit of U.S. Provisional Patent Application Ser. No. 61/200,806, filed Dec. 4, 2008, and Ser. No. 61/157,661, filed Mar. 5, 2009, is hereby claimed. The disclosures in said U.S. Provisional Patent Application Ser. Nos. 61/200,806 and 61/157,661 are incorporated herein by reference.

### BACKGROUND OF THE INVENTION

1. Field of the Invention

The present invention relates to displays for portable electronic devices.

2. Description of Related Art

Portable electronic devices are common in the marketplace. One example portable electronic device is the laptop computer. The terms “laptop computer” encompass a range of portable personal computers, for example from notebook computers to netbook computers, which differ primarily by size and weight. Another example portable electronic device is the so-called slate computer or tablet computer, which lacks the clam-shell housing commonly found on laptop computers. Still other example portable electronic devices are mobile phones (e.g., flip phones, slider phones, bar/slab phones such as the iPhone®, etc.) personal digital assistants (PDA), cameras, audio and/or video recorders, and portable media players. The terms “portable media player” encompass a range of portable audio and/or video players, such as MP3 players, compact disk (CD) players, and the like. A recent addition to this mix of devices is the eReader or eBook, which has been recently introduced as a replacement for books.

Portable electronic devices typically have a display device. Often the display device is a bright, light-emissive, color display, such as a liquid crystal display (LCD) or an organic light emitting diode (OLED) display. Such conventional displays require a constant supply of power to maintain an image. In contrast, the eReader, typically has a bistable, reflective display rather than a light-emissive display, to show readable images (e.g., pages of multi-page documents) with minimal power consumption. Example bistable, reflective displays include cholesteric LCDs (e.g., Reflex™ displays of Kent Displays, Inc.), electrochromic displays and electrophoretic displays (Eink, SiPix and Bridgestone).

A concept new to the electronic device market is the “electronic skin or eSkin” (see U.S. Patent Application Publication 2008/0074383) being introduced as a product differentiator. The eSkin allows customers to change the color of the portable electronic device housing electronically to reflect their personal style or coordinate with their attire, car or other possessions. U.S. Patent Application Publication 2007/0220427 describes a similar electronic skin that can indicate functional features with color such as ring tones, call waiting and missed calls.

### BRIEF SUMMARY OF THE INVENTION

A problem associated with portable electronic devices is that a typical user of such devices may have to carry multiple devices simultaneously. For example, a user may carry a mobile phone, a laptop computer and a portable media player simultaneously. The addition of an eReader exacerbates the problem. It would be desirable to incorporate the beneficial aspects of an eReader, i.e., the display of images with low power consumption, into existing portable electronic devices. It would be further desirable to incorporate the color-changing functionality of an eSkin into a portable electronic device having an eReader. Preferably, the display for an eReader incorporated into a portable electronic device would be inexpensive, low power, light weight, rugged, extremely thin and flexible to conform to the rounded shapes of a portable electronic device housing without changing the overall volume of the device, and capable of displaying high resolution images in bright colors with wide color gamut. If the display is a reflective display, it would be highly readable in direct sunlight.

In accordance with one aspect of the present invention, provided is a portable electronic device. The portable electronic device includes a portable electronic device housing having a surface and a primary, light-emissive display. A display skin covers a portion of the surface of the portable electronic device housing. The display skin provides a secondary, light-reflective display. The display skin includes an optically active layer comprising electrooptical material. A first electrode layer is disposed on a first side of the optically active layer proximal the surface of the portable electronic device housing. A second electrode layer is disposed on a second side of the optically active layer distal of the surface of the portable electronic device housing. Electronic circuitry selectively activates the optically active layer such that images including portions of a document are selectively displayed by the display skin. The display skin is capable of maintaining a display of a selectively displayed portion of the document while the primary display is in an unpowered state.

In accordance with another aspect of the present invention, provided is a removable case cover for a portable electronic device. The removable case cover includes a display skin covering a portion of a surface of the case cover. The display skin provides a light-reflective display. The display skin includes an optically active layer comprising electrooptical material. A first electrode layer is disposed on a first side of the optically active layer proximal the surface of the case cover. A second electrode layer is disposed on a second side of the optically active layer distal of the surface of the case cover. Electronic circuitry selectively activates the optically active layer such that images including portions of a document are selectively displayed by the display skin.

In accordance with still another aspect of the present invention, provided is a system comprising a portable electronic device and a removable case cover. The portable electronic device includes a portable electronic device housing, a light-emissive display, and a memory for storing image data comprising a document. The removable case cover covers a portion of the portable electronic device housing and is removable from the portable electronic device housing. The removable case cover has a surface and includes a display skin covering a portion of the surface. The display skin provides a secondary, light-reflective display. The display skin includes an optically active layer comprising electrooptical material. A first electrode layer is disposed on a first side of the optically active layer proximal the surface of the removable case cover. A second electrode layer is disposed on a second side of the optically active layer distal of the surface of the removable case cover. Electronic circuitry selectively activates the optically active layer such that images including document portions are selectively displayed by the display skin. The portable electronic device transmits the image data comprising the document to the removable case cover. The display skin displays a portion of the document and is capable of maintaining the display of the portion of the document while the light-emissive display is in an unpowered state.

The display skin can include no substrate, one substrate or two or more substrates. The display skin can be formed as a film on a release liner and then transferred to the housing of the portable electronic device or to the removable case cover. The use of different numbers of substrates and the transfer display film are disclosed in U.S. Patent Application Publication No. US 2007/0126674 entitled Liquid Crystal Display Films, which is incorporated herein by reference.

### BRIEF DESCRIPTION OF THE DRAWINGS

FIG. 1 is a schematic diagram of a display skin;

FIG. 2 is a schematic diagram of a display skin;

FIG. 3 shows a laptop computer;

FIG. 4 shows a laptop computer;

FIG. 5 shows a laptop computer;

FIG. 6 shows a mobile phone;

FIG. 7 shows a mobile phone;

FIG. 8 shows a mobile phone;

FIG. 9 shows a slate computer;

FIG. 10 shows a slate computer;

FIG. 11 shows a personal digital assistant;

FIG. 12 shows a portable media player;

FIG. 13 shows a case cover for a portable electronic device;

FIG. 14 shows a case cover for a portable electronic device;

FIG. 15 shows a portable electronic device with attached case cover;

FIG. 16 is a schematic block diagram; and

FIG. 17 is a schematic block diagram.

### DETAILED DESCRIPTION OF THE INVENTION

The present invention relates to displays for portable electronic devices, such as secondary displays in the form of display skins located on portable electronic device housings. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

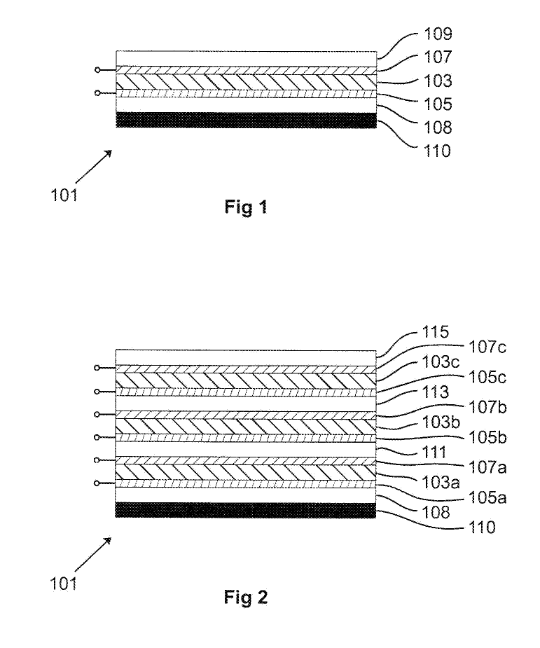

An electronic display skin 101 is schematically shown in FIG. 1. The electronic display skin 101 is a multilayer film having an optically active layer 103, a first electrode layer 105 disposed on a first side of the optically active layer and a second electrode layer 107 disposed on a second side of the optically active later. The electronic display skin 101 can have no substrates, or can include one or more substrates. A substrate is a structure that supports components of the display skin 101 and/or serves an electrically insulating or protective function. In FIG. 1, the first electrode layer 105 is located between a first substrate 108 and the optically active layer 103. The second electrode layer 107 is located between a second substrate 109 and the optically active layer 103. An optional light absorbing layer 110 is located beneath the first substrate 108. The light absorbing layer 110 can be omitted if the display skin 101 is placed onto a surface that absorbs light. Components and embodiments of the display skin are described in U.S. Pat. Nos. 7,170,481 entitled Single Substrate Liquid Crystal Display; 7,236,151 entitled Liquid Crystal Display; and 7,351,506 entitled Polymerization-encapsulated Cholesteric Liquid Crystal for Bistable Reflective Displays, which are incorporated herein by reference. U.S. Patent Application Publication No. US 2009/0284691 entitled Electronic Skin Having Uniform Gray Scale Reflectivity, which is incorporated herein by reference, discloses electronic skin that can be applicable to the present invention.

The optically active layer 103 comprises a reflective electrooptical material. The optically active layer 103 can comprise a bistable electrooptical material dispersed in a polymeric matrix, making it rugged for use as an eSkin and aiding its manufacturability on a web line. The electrooptical material can be bistable cholesteric liquid crystal material. Other reflective technologies that may be suitable for the applications discussed herein include electrophoretic displays, electrochromic displays and electrowetting displays. While these other technologies are a possible alternative to the bistable cholesteric displays, they do not have all of the combined features of bistable cholesteric displays such as multiplexibility, low current, polarizer free, and suitability for low cost continuous roll manufacturing.

The electrooptical material of the optically active layer 103 can be bistable and light-reflective so that no power is required to maintain a displayed image or displayed color. If the optically active layer is a liquid crystal layer, it may be made by PIPS (polymerization-induced phase separation), SIPS (solvent-induced phase separation), or TIPS (temperature-induced phase separation), or can be an emulsion in some designs, which are made in the manner disclosed in the U.S. Pat. Nos. 7,170,481, 7,236,151, and 7,351,506 patents.

The first electrode layer 105 and the second electrode layer 107 are transparent. Electrical interconnects extend from the electrodes to a location outside the display skin 101. Electronic circuitry associated with the display skin 101 applies voltages to the electrode layers 105, 107 via the interconnects, which enable the electrooptical material to be placed into a dark state, a bright state or gray scale states with intensity of reflection or brightness therebetween. The electrode layers 105, 107 are patterned and can be patterned in the form of a matrix of pixels (i.e., a passive matrix display). That is, the electrode layers 105, 107 can from a plurality of parallel column electrodes on one side of the electrooptical material and a plurality of parallel row electrodes on the other side of the electrooptical material, the columns being orthogonal to the rows. Such a passive matrix display is a multiplexed display. The pixels can be individually addressed to bright, dark or gray scale states to produce images on the display skin. Example materials to be used in forming the electrode layers 105, 107 include indium tin oxide (ITO) or a conducting polymer such as PEDOT.

Alternatively, an active matrix could be used to drive electrooptical material whereby the upper conductor is unpatterned and the lower conductor is patterned into individual pixels, each pixel driven by a transistor, diode or combinations of transistors.

Turning to FIG. 2, the display skin 101 can have a plurality of optically active layers 103a, 103b, 103c stacked on each other. Electrode layers 105a-c, 107a-c are disposed on either side of each optically active layer 103a-c. A first substrate 108 is located atop an optional light absorbing layer 110. A second substrate 111 separates electrode layers 105b and 107a. A third substrate 113 separates electrode layers 105c and 107b. A fourth substrate 115 covers electrode layer 107c. It is to be appreciated that the display skin 101 can include fewer or more than four substrates, as desired.

The optically active layers 103a-c can each be configured to reflect light of a specific color, thereby forming a bistable, color stackable display. For example, the first optically active layer 103a can be a red-light-reflecting layer. The second optically active layer 103b can be a green-light-reflecting layer. The third optically active layer 103c can be a blue-light-reflecting layer. Colored-light-reflecting optically active layers can be provided in any stacking order as desired. The colors provided by the optically active layers 103a-c can be additively mixed to provide a desired resultant color. Gray scale capability of the bistable cholesteric technology allows a broad variety of different colors, including different shades.

Another method to achieve a multiple color display is by use of a single bistable cholesteric layer that is patterned. In this embodiment, the reflective color of the cholesteric material is patterned by a means such as described, for example, in U.S. Pat. No. 5,668,614 (incorporated by reference). These colors occupy different areas of the display, but can combine to create a colored effect. This means of producing multiple-color has advantages in cost and manufacturing simplicity in electronic interconnects.

In order to increase the brightness of a cholesteric liquid crystal layer of the display skin 101, both the left and right circular components of the incident light may be reflected. There are two methods to accomplish this: to layer a cholesteric material of one handedness on top of the other or to insert a half wave plate in between two layers of the same handedness. One aspect of the invention coats sublayers of cholesteric materials of different handedness (left hand-LH and right hand-RH) on top of one another in the formation of the liquid crystal layer reflecting a certain wavelength of electromagnetic radiation.

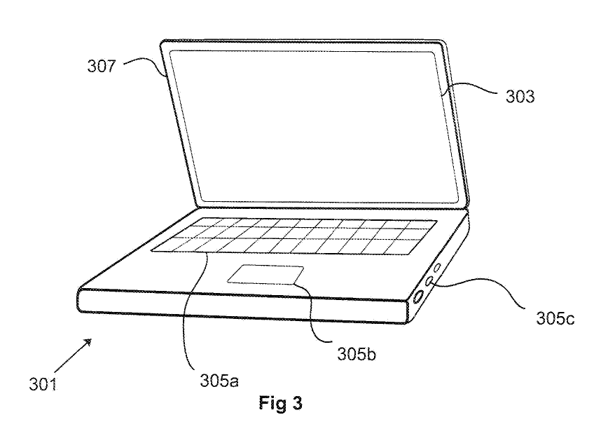

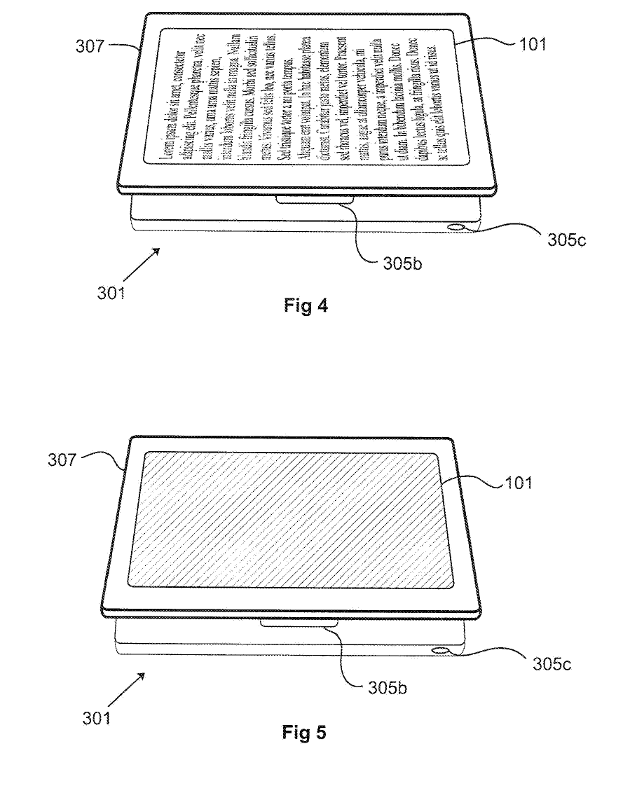

Turning to FIG. 3 through FIG. 5, the display skin 101 is shown applied to a portable electronic device housing, covering a portion of the surface of the housing to form a secondary, light-reflective display for the portable electronic device. In FIG. 3 through FIG. 5, the portable electronic device is a laptop computer 301. The laptop computer 301 has a primary, light-emissive display 303, such as an LCD display, and a plurality of user interface devices 305a-c. Example user interface devices include keys, touchpads, buttons, and the like.

When applied to the portable electronic device housing, the display skin 101 will include at least one optically active layer and electrode layers disposed on either side of the optically active layer. One of the electrode layers will be proximal the surface of the portable electronic device housing and the other electrode layer will be distal of the surface of the portable electronic device housing. The proximal electrode layer can be located atop a substrate layer and another substrate layer can be provided over the distal electrode layer to protect the display skin 101.

The display skin 101 can selectively display single images. For example, the display skin 101 can display pictures (e.g., photographs) or portions of a document such as one or more pages of a multi-page document (e.g., a book, a report, a memo, a presentation, an advertisement, etc.). It is to be appreciated that the document can also be displayed on the primary display 303. However, the primary display consumes more electrical power when operating than does the display skin 101. The display skin 101 can be bistable and light-reflecting and, therefore, only consumes electrical power when changing the displayed image. Unlike the primary display 303, such a display skin 101 can display an image indefinitely without consuming power. The display skin 101 consumes a small amount of power when changing the displayed image, for example when switching from one page to another page of the document. The display skin 101 is capable of maintaining a display of a selectively displayed image, such as a portion of a document, while the primary display and/or the display skin is in an unpowered state.

The primary display 303 has a light-emissive ON state (e.g., a powered state) and a non-light-emissive OFF state (e.g., an unpowered state). To conserve the laptop's battery power, the display skin 101 can display images while the primary display 303 is in the OFF state. It is to be appreciated that the display skin 101 and the primary display 303 can display identical or different images simultaneously.

In addition to displaying images, the display skin 101 can display solid colors (shown schematically in FIG. 5) in various degrees of brightness, shades of gray, and/or patterns to personalize the portable electronic device. For example, the display skin 101 can appear blue, red, green, or as other colors when the primary colors are mixed. The display skin can also display a pattern, such as a red heart. The display skin 101, therefore, can function as both an eReader and an electronic skin or eSkin. When not being used as an eReader, the display skin 101 can default to displaying a particular color or pattern.

Image data providing the images (e.g., pictures, documents, etc.) to be displayed by the display skin 101 are stored in a memory device associated with the portable electronic device. For example, image data of a book or other document can be saved on the laptop's 301 hard drive, on a USB flash memory, on a CD-ROM, etc. The laptop 301 causes the image data to be transmitted to electronic circuitry (e.g., a display controller and display driver) within the laptop that activates the optically active layer(s) of the display skin 101 to create the displayed images.

Using the display skin 101 as an eReader takes advantage of the powerful electronics already included in the laptop 301 to offer user functionality beyond that of a standalone reader. For example, the laptop 301 can function as a normal computer with a high power display when its cover is open and as an eReader operating in a low power mode with the cover closed. In the low power mode, most of the functionality of the laptop 301 can be disabled or powered down except for the functionality associated with selectively displaying images on the display skin 101. This might be accomplished by having an additional specialized low-power controller and display drive electronics separate from the laptop processor (such as a separate memory for storing pages that operates independently from the laptop processor, for example). In any case, the processing requirements, and hence the power requirements, can be much less than those that are typically utilized by a fully powered laptop. Significant cost savings over using a separate laptop and eReader are realized since the processor, memory and communication electronics can be shared. The incremental manufacturing cost of an integrated laptop and eReader/eSkin consists of the display skin 101 and its controller(s)/driver(s).

Whether operating in the normal, high power mode or in the low power eReader mode, the user interface devices 305a-c of the laptop 301 can be used to control operations of the display skin 101. Preferably, operations of the display skin 101 are controlled by a user interface device that is accessible with the laptop cover closed so that documents can be opened and different pages viewed without opening the laptop cover. An example of such a user interface device is a button located on a side or a top surface of the laptop housing. User activation of one or more of the interface devices 305a-c can cause documents to be opened, closed, have different pages displayed, control viewing options such as page rotation, zooming functions, etc., and control document editing operations such as text highlighting if available.

It is to be appreciated that by placing the display skin 101 on the laptop housing 307 as shown and using it as an eReader, the benefits of the eReader and eSkin are incorporated into a single physical device. The single physical device retains all of its original functionality, while its weight, volume, shape, and battery life are not significantly impacted. Further, the display skin 101 can be made transparent when not displaying images, allowing the surface of the laptop housing and any artwork or logos thereon to be seen.

In addition or alternative to locating the display skin 101 on a portable electronic device housing, the display skin can occupy the space of the primary display. That is, the display skin can be located on an outer surface of the primary display. Such a secondary display would be one that can be seen through (i.e., is substantially transparent) so that the image of the primary display (for example a backlit LCD, OLED or electroluminescent display) can be viewed through the secondary display when the backlight or emissive elements of the primary display are turned on and in use. When the primary display is turned off (backlight or emissive elements turned off) the black background of the primary display serves as a contrasting background for the reflective secondary display and the reflective image on the secondary display can be viewed. Reflective display technologies that offer such transparent characteristics are the bistable cholesteric display technology and forms of the electrowetting display technologies. In the case where the secondary display is the preferred bistable cholesteric technology, the secondary display would not employ a light absorbing (e.g., black) back layer. The contrast for the images of the secondary reflective cholesteric display would be obtained when the primary display behind it is off and/or dark. The secondary cholesteric display would be substantially transparent when the backlight or emissive elements are on so that it and its reflective image would not significantly interfere with the image from the primary display. The secondary cholesteric display would be more see-through when it is driven to the homeotropic state while the backlight of the primary display is turned on.

Locating the display skin on the outer surface of the primary display would further protect the secondary display in the same manner in which the primary display is protected (e.g., being inside the cover of a clam shell housing), rather than exposing the secondary display to the wear and tear experienced by the portable electronic device housing. Further, the substantially transparent secondary display would be particularly suitable for the slate computer which has no cover for the primary display.

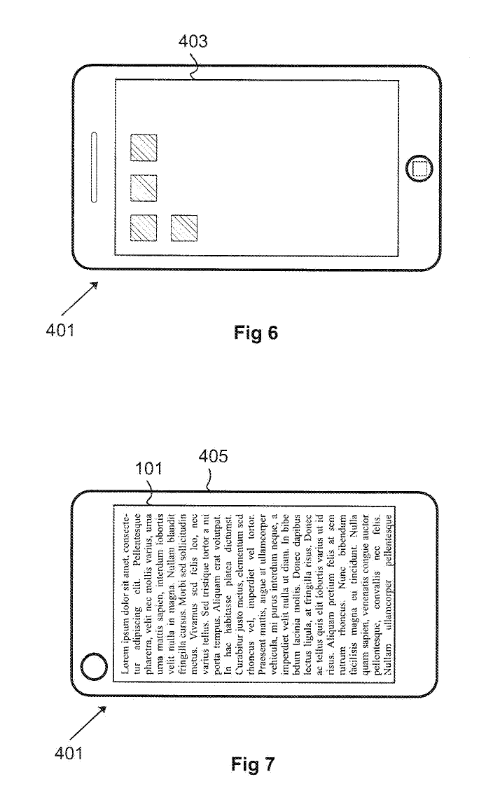

Turning to FIG. 6 through FIG. 12, it can be seen that the display skin 101 can be implemented on a variety of portable electronic devices. FIG. 6 and FIG. 7 show a mobile phone 401 with a bar or slab form factor (e.g., an iPhone®). A primary display 403 is located on a first side of the mobile phone 401, as shown in FIG. 6. The display skin 101, which forms a secondary display, is located on the mobile phone housing 405 on a second side of the phone. Documents can be downloaded to the mobile phone 401 and viewed on the display skin 101, which operates as an eReader. It is to be appreciated that the display skin 101 can function as a display to allow images to be viewed in bright sunlight conditions that wash out the primary display. As discussed above, when the display skin 101 is not being used as an eReader, the display skin 101 can function as an eSkin to customize the mobile phone 401.

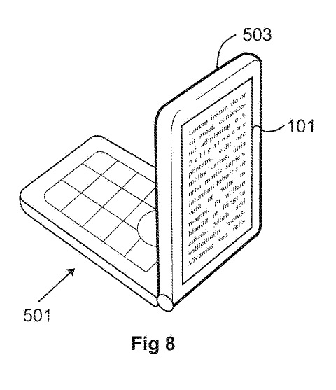

FIG. 8 shows the display skin 101 located on the housing 503 of a flip phone 501.

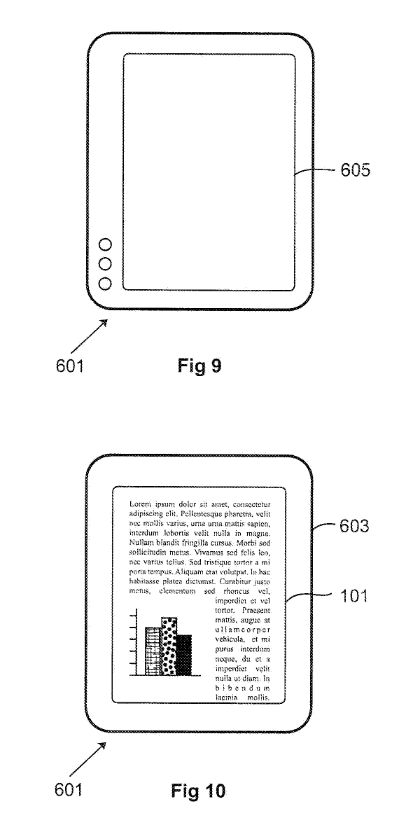

FIG. 9 and FIG. 10 show the display skin 101 located on the housing 603 of a slate computer 601. A primary display 605 is located on a first side of the slate computer 601, as shown in FIG. 9 and the display skin 101 is located on the opposite side of the computer, as shown in FIG. 10. It is to be appreciated that the display skin 101 could be located on top of the primary display 605 as discussed above.

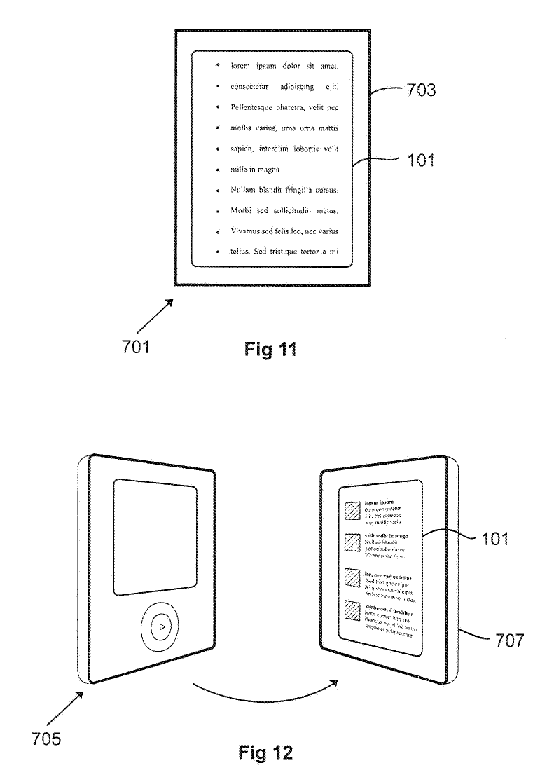

FIG. 11 shows the display skin 101 located on the housing 703 of a PDA 701.

FIG. 12 shows the display skin 101 located on the housing 707 of a portable media player 705, such as an MP3 player. The left side of FIG. 12 shows the front surface of the portable media player 705, and the right side shows its rear surface.

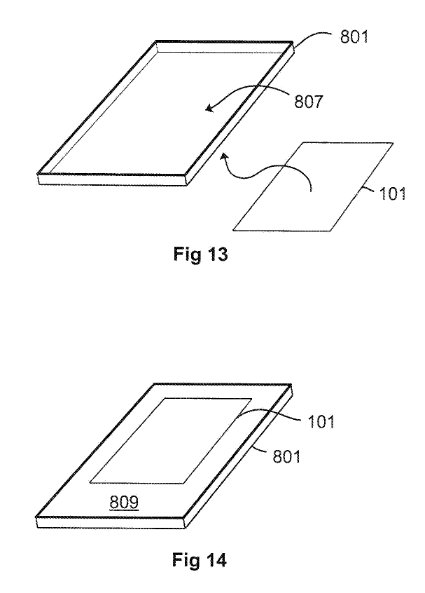

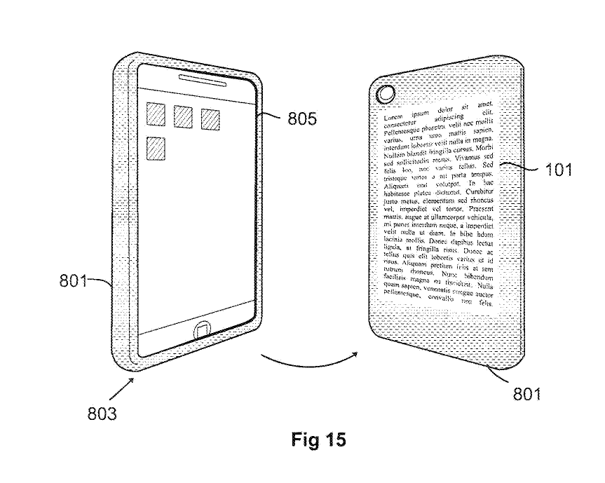

FIG. 13 through FIG. 15 show an embodiment in which the display skin 101 is located on a removable case cover 801 (e.g., a protective slip cover) for a portable electronic device 803. In FIG. 15, the portable electronic device is a mobile phone having a primary, light-emissive display 805. It is to be appreciated that the removable case cover 801 is not limited to use with mobile phones, but could be used with any type of portable electronic device, such as the various portable electronic devices discussed herein. For example, a removable case cover could cover one or both halves of a laptop computer housing.

The removable case cover 801 typically snaps onto the portable electronic device housing or tightly engages the portable electronic device housing. Example case covers 801 include hard shell case covers, more flexible case covers, and highly flexible and form fitting skin cases. The case cover 801 has an opening 807 for receiving the portable electronic device 803. Opposite the opening 807 for receiving the portable electronic device 803 is a surface 809 (e.g., forming an outer surface of the electronic device when the case cover engages the housing of the device). The display skin 101 is located on the surface 809 of the case cover 801. When the portable electronic device 803 is inserted into the case cover 801, or the case cover 801 is otherwise attached to the portable electronic device 803, the display skin 101 covers a portion of the portable electronic device housing.

Although the display skin 101 is located on the removable case cover 801 rather than directly on the portable electronic device housing, the display skin 101 provides the functionality discussed above. For example, documents can be downloaded to the portable electronic device 803 and viewed on the display skin 101, which operates as an eReader. When the display skin 101 is not being used as an eReader, the display skin 101 can function as an eSkin to customize the portable electronic device 803 and/or the case cover 801.

The removable case cover 801 includes embedded or integral electronics, such as a display controller, display driver, and memory, for controlling operations of the display skin 101. Image data is transmitted to the removable case cover 801 from the portable electronic device 803, either wirelessly or via a hardwired connection. Example transmission methods include Bluetooth, infrared, and USB.

The case cover 801 can include a battery for supplying power to the case cover. Alternatively, the case cover 801 can be powered by the portable electronic device 803 via an electrical connection that is established when the case cover 801 is attached to the device.

It is to be appreciated that the case cover 801 can be configured to place the display skin 101 over the primary display 805 of the portable electronic device 803. In this case, the secondary display formed by the display skin 101 would be one that is substantially transparent so that the image of the primary display can be viewed through the secondary display when the backlight or emissive elements of the primary display are turned on and in use. When the primary display is turned off (backlight or emissive elements turned off) the black background of the primary display serves as a contrasting background for the reflective secondary display and the reflective image on the secondary display can be viewed. The secondary display would be substantially transparent when the backlight or emissive elements are on so that it and its reflective image would not significantly interfere with the image from the primary display.

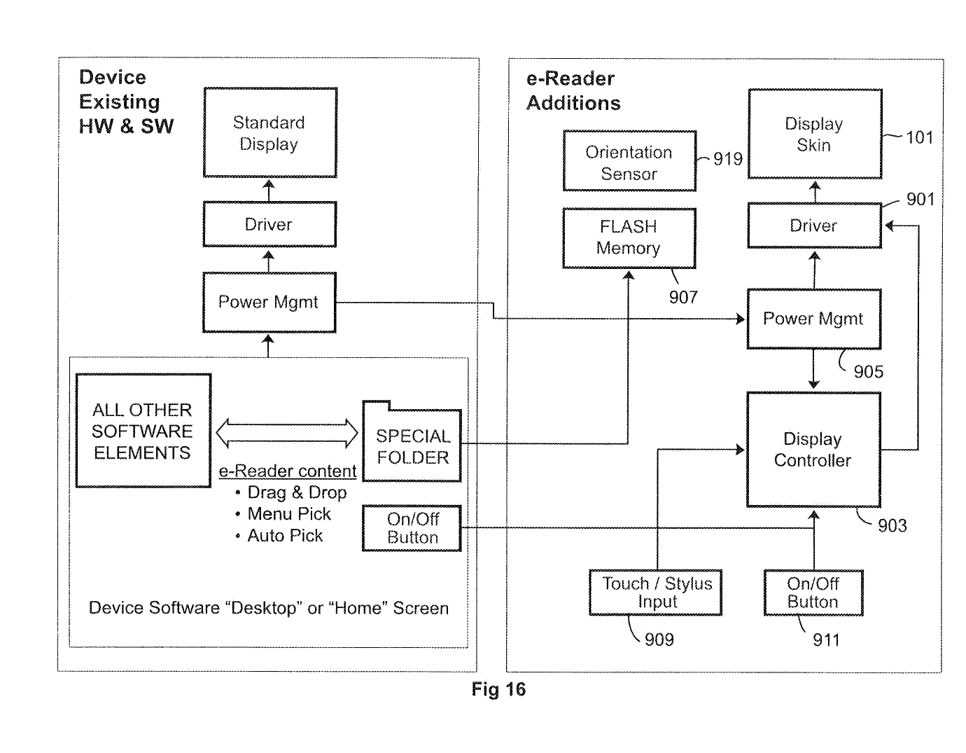

The portable electronic devices discussed above can include means for automatically placing the primary, light-emissive display into an OFF state and automatically activating the secondary, light-reflective display based on sensing that the portable electronic device has been flipped over. Flipping the portable electronic device over will tend to conceal the primary display and expose the secondary display to the user. The portable electronic device can include a sensor 919 (see FIG. 16), such as a switch, that is activated when the device is flipped over. A controller within the portable electronic device receives a signal from the sensor to determine that the device has been flipped over. In response to the signal, the controller causes the primary display to turn OFF and activates the secondary display.

FIG. 16 shows a schematic block diagram of electronic circuitry associated with a portable electronic device and display skin 101. Minimal additional electronics are required for the display skin 101 as illustrated in FIG. 16. This is a result of sharing processor, memory and communications of the portable electronic device. As with any display these electronics contain a driver 901, display controller 903, power management 905. Optionally, additional memory 907 and user interface devices 909, 911 can be added to the portable electronic device to control operations of the display skin 101. Once an image (or page) is selected and transferred to the display skin 101, no power is required until that image or page is changed. Changing pages or images while in eReader mode can be accomplished with a variety of low power touch sensitive buttons or surfaces, and in some cases where necessary by utilizing specialized low-power, low-performance electronics, without “waking up” other electronics in the portable electronic device.

FIG. 16 is divided into two sections, right and left. The left hand section is a block diagram of the major components found in a typical portable electronic device. The right hand section shows the major components which could be added to a portable electronic device to transform it into an eReader. These components require little or no power when not in use and minimal power when in use as an eReader. Known conventional eReaders have a processor, memory, and a network communication section. In the eReader devices of this disclosure, these are already available via the parent portable electronic device at no additional cost, or additional specialized low-power, low-performance electronics can be added at a minimal cost, perhaps providing additional power savings. It is also the case that conventional “parent devices” typically already contain the means or interfaces to transfer the user selected documents and images into the eReader memory.

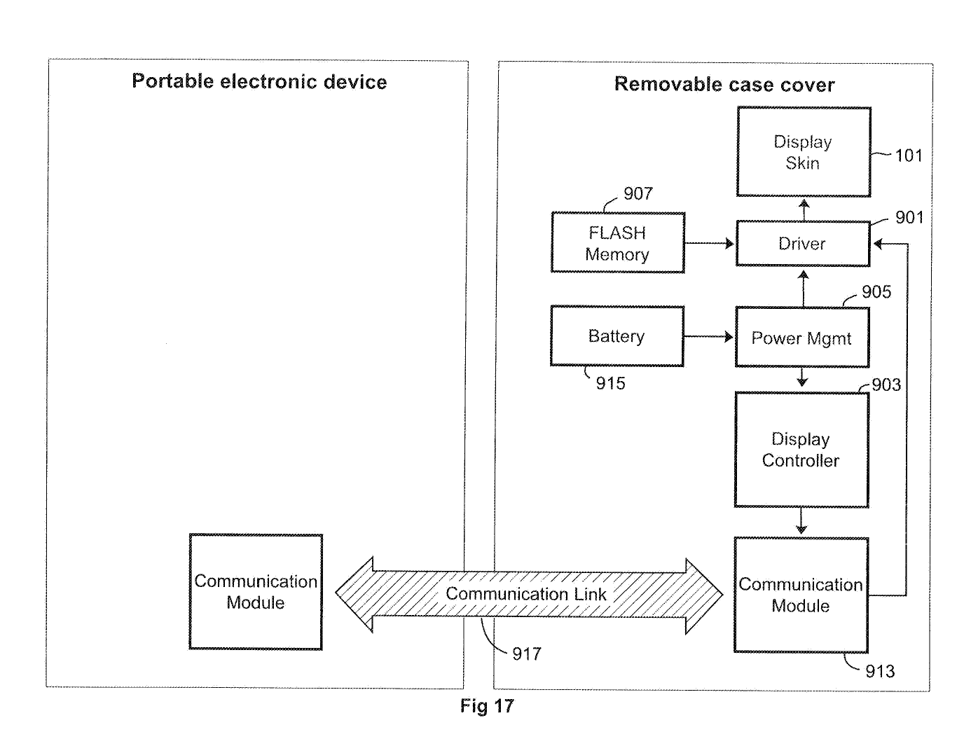

FIG. 17 shows a schematic block diagram of electronic circuitry located within a removable case cover having the display skin 101. The removable case cover will typically be an aftermarket addition to the portable electronic device. In addition to the driver 901, display controller 903, power management 905, and memory 907 discussed above, the removable case cover includes a communication module 913 and can include a battery 915. The removable case cover receives image data transmissions and other data transmissions from the portable electronic device over a communications link 917. The communications link can be a wireless communication link, such as Bluetooth, or a hardwired connection. Note that the functional relationship between the portable electronic device and the display skin 101 remains the same as described in FIG. 16.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A portable electronic device, comprising:
a portable electronic device housing having a surface;
a primary, light-emissive display; and
a display skin covering a portion of the surface of the portable electronic device housing and providing a secondary, light-reflective display, the display skin comprising:
an optically active layer comprising electrooptical material;
a first electrode layer disposed on a first side of the optically active layer proximal the surface of the portable electronic device housing;
a second electrode layer disposed on a second side of the optically active layer distal of the surface of the portable electronic device housing; and
electronic circuitry for selectively activating the optically active layer such that images including portions of a document are selectively displayed by the display skin,
wherein the display skin is capable of maintaining a display of a selectively displayed portion of the document while the primary display is in an unpowered state.

2. The portable electronic device of claim 1, wherein the electronic circuitry selectively activates the optically active layer such that solid colors are selectively displayed by the display skin.

3. The portable electronic device of claim 1, wherein the display skin further comprises a first substrate and a second substrate,
wherein the first electrode layer is located between the first substrate and the optically active layer, and the second electrode layer is located between the second substrate and the optically active layer, and
wherein electrodes of the first electrode layer are oriented orthogonal to electrodes of the second electrode layer to form a multiplexed passive matrix display.

4. The portable electronic device of claim 1, wherein the display skin is located on the surface of the portable electronic device housing.

5. The portable electronic device of claim 1, further comprising a case cover that is removable from the portable electronic device housing, wherein the display skin is located on a surface of the case cover.

6. The portable electronic device of claim 1, wherein the document is a multi-page document,
wherein the primary, light-emissive display has a light-emissive ON state and a non-light-emissive OFF state,
wherein the electronic circuitry selectively activates the optically active layer such that at least one page of the multi-page document is displayed while the primary, light-emissive display is in the OFF state, and
wherein the display skin is capable of maintaining the display of the at least one page while the display skin is in an unpowered state,
the portable electronic device further comprising a user interface device, wherein the electronic circuitry selectively activates the optically active layer such that a different at least one page of the multi-page document is displayed in response to an activation of the user interface device.

7. The portable electronic device of claim 6, further comprising means for automatically placing the primary, light-emissive display into the OFF state and automatically activating the secondary, light-reflective display based on sensing that the portable electronic device has been flipped over.

8. The portable electronic device of claim 1, wherein the electrooptical material is bistable electrooptical material dispersed in a polymeric matrix.

9. The portable electronic device of claim 1, wherein the electrooptical material is bistable cholesteric liquid crystal material and wherein the display skin is capable of maintaining the display of the portion of the document while the display skin is in an unpowered state.

10. The portable electronic device of claim 1, wherein the display skin is one of an electrowetting display and an electrophoretic display.

11. The portable electronic device of claim 1, wherein the display skin includes stacked liquid crystal layers and wherein the stacked liquid crystal layers include a red-light-reflecting layer, a green-light-reflecting layer, and a blue-light-reflecting layer.

12. The portable electronic device of claim 1, wherein the portable electronic device is one of a laptop computer, a slate computer, a mobile phone, a personal digital assistant (PDA), and a portable media player.

13. A removable case cover for a portable electronic device, comprising:
a display skin covering a portion of a surface of the case cover and providing a light-reflective display, the display skin comprising:
an optically active layer comprising electrooptical material;
a first electrode layer disposed on a first side of the optically active layer proximal the surface of the case cover;
a second electrode layer disposed on a second side of the optically active layer distal of the surface of the case cover; and
electronic circuitry for selectively activating the optically active layer such that images including portions of a document are selectively displayed by the display skin.

14. The removable case cover of claim 13, wherein the display skin further comprises a first substrate and a second substrate,
wherein the first electrode layer is located between the first substrate and the optically active layer, and the second electrode layer is located between the second substrate and the optically active layer, and
wherein electrodes of the first electrode layer are oriented orthogonal to electrodes of the second electrode layer to form a multiplexed passive matrix display.

15. The removable case cover of claim 13, wherein the electronic circuitry selectively activates the optically active layer such that solid colors are selectively displayed by the display skin.

16. The removable case cover of claim 13, wherein the document is a multi-page document,
wherein the electronic circuitry selectively activates the optically active layer such that at least one page of the multi-page document is displayed, and
wherein the display skin is capable of maintaining the display of the at least one page while the display skin is in an unpowered state.

17. The removable case cover of claim 13, wherein the electrooptical material is bistable cholesteric liquid crystal material, and wherein the display skin is capable of maintaining a display of a portion of the document while the display skin is in an unpowered state.

18. The removable case cover of claim 13, wherein the electrooptical material is bistable electrooptical material dispersed in a polymeric matrix.

19. The removable case cover of claim 13, wherein the display skin is one of an electrowetting display and an electrophoretic display.

20. The removable case cover of claim 13, wherein the display skin includes stacked liquid crystal layers and wherein the stacked liquid crystal layers include a red-light-reflecting layer, a green-light-reflecting layer, and a blue-light-reflecting layer

21. A system, comprising:
a portable electronic device, the portable electronic device comprising:
a portable electronic device housing;
a light-emissive display; and
a memory for storing image data comprising a document; and
a removable case cover, covering a portion of the portable electronic device housing, and that is removable from the portable electronic device housing, the removable case cover having a surface, and the removable case cover comprising a display skin covering a portion of the surface of the removable case cover and providing a secondary, light-reflective display, the display skin comprising:
an optically active layer comprising electrooptical material;
a first electrode layer disposed on a first side of the optically active layer proximal the surface of the removable case cover;
a second electrode layer disposed on a second side of the optically active layer distal of the surface of the removable case cover; and
electronic circuitry for selectively activating the optically active layer such that images including document portions are selectively displayed by the display skin,
wherein the portable electronic device transmits the image data comprising the document to the removable case cover, and
wherein the display skin displays a portion of the document and is capable of maintaining the display of the portion of the document while the light-emissive display is in an unpowered state.

22. The system of claim 21, wherein the electronic circuitry selectively activates the optically active layer such that solid colors are selectively displayed by the display skin.

23. The system of claim 21, wherein the display skin further comprises a first substrate and a second substrate,
wherein the first electrode layer is located between the first substrate and the optically active layer, and the second electrode layer is located between the second substrate and the optically active layer, and
wherein electrodes of the first electrode layer are oriented orthogonal to electrodes of the second electrode layer to form a multiplexed passive matrix display.

24. The system of claim 21, wherein the document is a multi-page document,
wherein the electronic circuitry selectively activates the optically active layer such that at least one page of the multi-page document is displayed,
wherein the display skin is capable of maintaining the display of the at least one page while the display skin is in an unpowered state,
wherein the portable electronic device comprises a user interface device, and
wherein the electronic circuitry selectively activates the optically active layer such that a different at least one page of the multi-page document is displayed in response to an activation of the user interface device.

25. The system of claim 21, wherein the electrooptical material is bistable cholesteric liquid crystal material, and wherein the display skin is capable of maintaining the display of the portion of the document while the display skin is in an unpowered state.

26. The system of claim 21, wherein the electrooptical material is bistable electrooptical material dispersed in a polymeric matrix.

27. The system of claim 21, wherein the display skin is one of an electrowetting display and an electrophoretic display

28. The system of claim 21, wherein the display skin includes stacked liquid crystal layers and wherein the stacked liquid crystal layers include a red-light-reflecting layer, a green-light-reflecting layer, and a blue-light-reflecting layer.

29. The system of claim 21, wherein the portable electronic device is one of a laptop computer, a slate computer, a mobile phone, a personal digital assistant (PDA), and a portable media player.
